(19) United States
(12) Patent Application Publication
(10) Pub. No.: US 2016/0180051 A1
(43) Pub. Date: Jun. 23, 2016

(54) METHOD AND ARRANGEMENT FOR MATCHING OF DISEASES AND DETECTION OF CHANGES FOR A DISEASE BY THE USE OF MATHEMATICAL MODELS

(71) Applicant: YOUR.MD AS, Oslo (NO)

(72) Inventor: Harald JELLUM, Oslo (NO)

(73) Assignee: YOUR.MD AS, Oslo (NO)

(21) Appl. No.: 14/912,019

(22) PCT Filed: Aug. 8, 2014
(86) PCT No.: PCT/NO2014/050141

§ 371 Date: Feb. 12, 2016

(30) Foreign Application Priority Data
Aug. 12, 2013 (NO) 20131100

(51) Int. Cl. G06F 19/00

(52) U.S. Cl. CPC G06F 19/3437; G06F 19/322

(57) ABSTRACT

Techniques for matching of diseases and detection of changes for a disease by use of mathematical models that make it possible to match, find similar diseases, properties between two or more diseases based on a set of symptoms, and detect changes in a disease.

### CROSS REFERENCE TO RELATED APPLICATIONS

This application is a U.S. National Stage patent application of PCT/NO2014/050141, filed on Aug. 8, 2014, which claims priority to Norwegian Patent Application No. 20131100, filed on Aug. 12, 2013, each one of which is hereby incorporated by reference in entirety.

### BRIEF DESCRIPTION OF THE DRAWINGS

The description of the invention is accompanied by the figures of which:

FIG. 1 is a block diagram overview of the system.

FIG. 2 is a block diagram overview of the Search and matching process.

FIG. 3 is a mathematical representation of a disease.

FIG. 4 is a mathematical comparison of characteristics/symptoms of two diseases.

FIG. 5 is showing mathematical changes of a disease symptoms.

### DETAILED DESCRIPTION OF THE INVENTION

Method and arrangement for matching of diseases and detection of changes for a disease by use of mathematical models that make it possible to match, find similar diseases, properties between two or more diseases based on a set of symptoms, and detect changes in a disease. The method uses mathematical representation models for diseases and is suitable for making a large number of comparisons automatically. The properties of the diseases are represented with different vectors (74). The direction and length of the vectors are compared by using the scalar product of these (76). Changes of the characteristics of a disease appear as changes in the vector direction and length. By continuously monitoring the derivative of the disease characteristics shows how big and how fast a change has occurred (78). The market for this invention are patients, relatives, family, friends, doctors, nurses, holistic and alternative medicine professionals or other professionals in the health profession who want to find possible diagnosis/disease based on a set of symptoms and who want to monitor changes in symptoms and thus the possible new changes for the diagnosis/disease. The market is global.

The invention is a completely new way of matching, finding similar diseases, characteristics between two or more diseases based on a set of symptoms and detecting changes in a disease. The method use mathematical representation models for diseases and is very well suited for a computer program doing a large number of comparisons automatically. The market for this invention comprises patients, relatives, family, friends, doctors, nurses, holistic and alternative medicine professionals or other professionals in the health profession who want to find possible diagnosis/disease based on one set of symptoms and who want to monitor changes in symptoms and thus potential new or changes in diagnosis/disease. The invention may be made available to users through a portal on the Internet and through downloadable applications that can be accessed via mobile phone, tablet, PC/Mac or other internet/communication devices for display of content data. The market is global.

When the word disease is used in this document, it should be understood that this shall comprise but not be limited to the meaning: illness, sickness, disease, malady, ailment, disorder, complaint, or affection.

The claimed invention is defined by the accompanying independent claim and further embodiments by the dependent claims.

Traditional methods to find, match, find similar diseases, and characteristics between two or more diseases based on a set of symptoms, and to detect changes in a disease often consists of researching multiple information sources and where a manual comparison must be performed.

These may typically comprise:

Research in databases/directories: There are currently many database/directory services where you can find possible diseases based on symptoms. Examples of these services may be www.WebMD.com or www.Patient.co.uk. Typical of these is that they contain information based on structured databases, very often these are proprietary and local. The challenge of these database enquiries is that it's a traditional database enquiries where it is necessary to specify the symptoms exact and very correctly written to generate correct matches. These matches are also merely based on the data in this one database. If one symptom is mistyped it may have major consequences for the result. If you want to see alternative diseases or other resembling illnesses it is necessary to do more enquiries in various databases and specifying varying symptoms. This is a manual and time consuming process.

Lookup via search engines: Enquiries and search for diseases with a specific set of properties can be done through keyword search using internet search engines like Google, Bing or others. The advantage with these types of search engines are that one can search with more details than database lookup as Internet search engines often have indexed all Web pages. The challenge is that the result often comprises a lot of hits that are perceived as noise and it is very time consuming to separate out the relevant search results. Another major challenge is that one cannot search too many symptoms simultaneously since it is a danger that many relevant web pages using other words or descriptions which is not matching the search term. This often results in missing relevant hits because the description of the relevant disease is described by using a different wording than the searched keyword phrases or phrases combination.

Consultation with a doctor: Traditionally this is the most common way to find diseases based on symptoms. Some of the challenges in this regard is availability, time consumption, costs and the doctor's experience, expertise and access to data on the short time that is normally available in a consultation. Experience from the USA indicates that of those who requested a second opinion gets up to 30% of these a different conclusion, and within breast cancer will 50% of those who seek a second opinion receive a different advice. In the United States alone 200,000 patients die each year due to erroneous treatment. Doctors are different, no one have access to all knowledge and experience, some tends to more conservative medicine whilst others are more open to modern development in medicine which that may lead to very different conclusions for a patient.

Alternative Medicine: In case where a person cannot find the solution related to their symptoms, holistic and alternative medicine can be an alternative giving hope where no obvious relations between symptom and illness.

Social Media: There are currently a number of forums, social websites for people with different symptoms and diseases. These peoples can find each other and share their own experiences and thereby find more information about diseases. The challenge is often that much of this content is based on people's subjective descriptions and often describes the frustrations of not finding answers. Consequently, a lot of time is used to filter out and locate relevant information.

Read about symptoms/diseases from various medical articles: Today there are numerous medical articles that are made available on the internet. It is possible to study these articles about the various diseases and symptoms which are disclosed and thus compare and match the symptoms and diseases. This is a very time consuming and manual process.

Based on the various methods available today for finding, matching, looking for similar illnesses or properties between two or more diseases based on a set of symptoms as well as discovering changes in a disease, this is with available technology today based on keyword searches that require exact definitions. The invention disclosed herein is to define a mathematical way of describing and comparing diseases based on symptoms that enables one to a greater degree to look at all the content and the overall picture instead of precise keywords. Thereby, one can describe symptoms in many different ways but still match the content. This provides a new dimension in looking for connections between symptoms and diseases without precise keywords, based on content comparisons both from structured databases and from unstructured web information.

The invention utilizes vector mathematics in a new combination for the representation of the diseases/symptoms based on information collected using search engine technology from various structured and unstructured sources.

The invention may lead to a new way of matching, finding similar diseases, properties shared by two or more diseases based on a set of symptoms and detecting changes in a disease. This can assist patients in getting a second opinion both on symptoms, illness/diseases and treatments. Subsequently, this may lead to greater precision for selection of treatments which consequently may lead to more healthy peoples, and resulting in positive consequences for individuals and the community as a whole.

Based on all the above, there is a need for a new way of matching, finding similar diseases, properties shared by two or more diseases based on a set of symptoms and detecting changes in a disease. The above problems are addressed by the invention described herein.

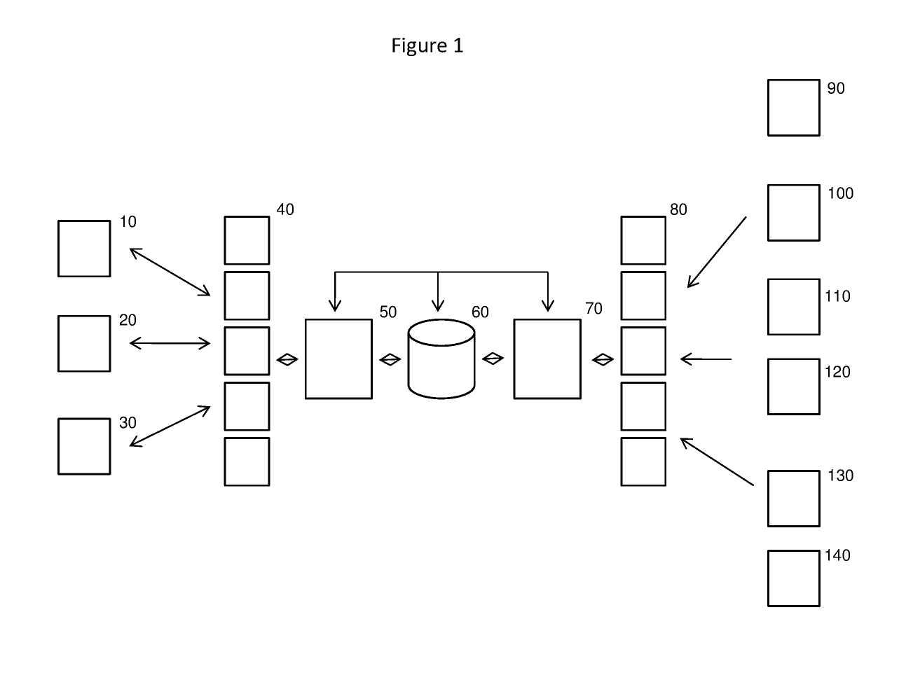

The invention relies on the use of databases, advanced search and matching technology using mathematical models combined with social media. Based on FIG. 1, the invention comprises a server farm consisting of servers for Crawlers (80), Search and Matching (70), Database (60), Social Media (50) and Web servers (40). The purpose of Crawlers (80) is initially to read all the information sources (90, 100, 110, 120, 130, 140), and the Search and Matching (70) will make a mathematical model of each disease. Then, Crawlers (80) will continuously read all the information sources (90, 100, 110, 120, 130, 140) searching for changes and updates. The mathematical models are then adjusted and stored in the Database (60).

Information sources (90, 100, 110, 120, 130, 140) consists of Web pages of public hospitals, private clinics and alternative treatments (90) that are crawled in the same manner as in a standard search engine. The multiple sources of information may comprise: Databases and registers such as Medical databases, and private and public records (100) may be both open and closed. There can be multiple databases or registers within each of information sources (100). Online medical experts (110) can originate from own or external forums, blogs, groups or other “communities”. Patients (10, 120), professionals in the health profession (30, 120), family and friends (20, 120), others having the same disease (120), which provides feedback on their experience, perception, treatment or other relevant information in regards of related symptoms, illness or treatment. News (130) comprising news streams continuously updated with news from newspapers, magazines, radio, TV, organizations, municipalities, agencies, political parties, or the like, that may be provided by 3rd party suppliers (e.g. MoreOver, Cyberwather or others).

Similarly to the News (130) one will receive news feeds from Forums, Blogs, and Social Networking (140) provided by 3rd parties. The users (10, 20, 30) of the invention will access the invention via an internet portal which is made available through Web servers (40). When the database (60) has received all information from the information sources (90, 100, 110, 120, 130, 140) with the exception of patients, professionals in the health profession, family, friends, and others with the same disease (120) that are added once the invention is launched for use, all users (10, 20, 30) may find help in finding diseases based on symptoms from day one. The user may participate in groups sorted by diseases, and meet other users with the same interest and receive good advices related to correlations between symptoms and diseases as well as being able to follow development and success stories of other users. One of the unique characteristics of this invention is that with all this information from all sources of information (90, 100, 110, 120, 130, 140) the user may access a unique collection of data combined to provide the user a best possible way to match, find similar diseases, properties shared between two or more diseases based on a set of symptoms, and to detect changes in a disease.

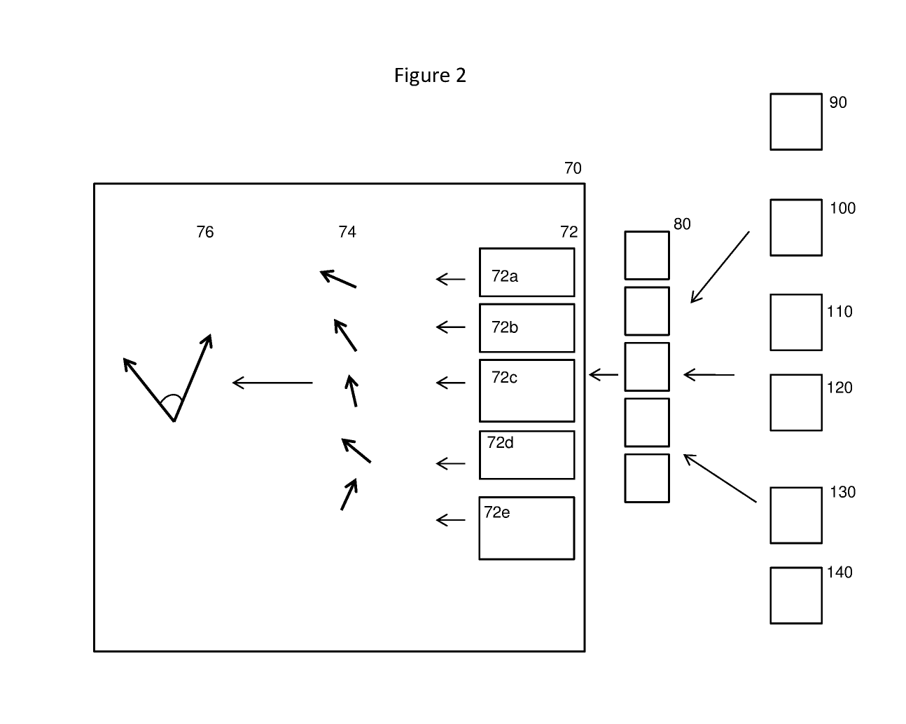

The Search & Matching method and arrangement of the invention is described in FIGS. 2, 3, 4 and 5 and is discussed in the following:

In FIG. 2, the Search & Matching (70) overview information about symptoms and disease is received from Crawlers (80). This information is categorized (72) in respect of where it comes from and what kind of information it is. This can comprise information about symptoms (72a), body location (72b) of the symptoms, pain intensity/shape/color etc. (72c), duration of the symptoms (72d) or other relevant symptoms and characteristics (72e). Each of these now categorized (72) properties is then represented mathematically by means of their respective vector having a direction and length in a multi-dimensional coordinate system (74). The characteristics of a disease can now easily be compared by comparing direction and length of the scalar product between two vectors (76).

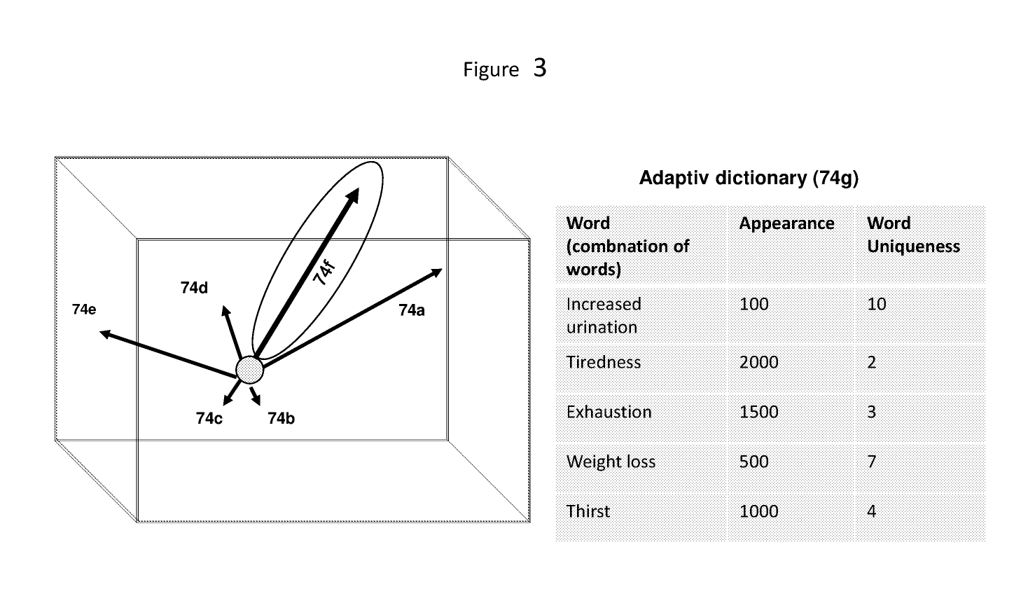

In FIG. 3 the Mathematical representation of a disease can be seen, and how such a vector is constructed. FIG. 3 shows an example of a disease presented by its symptoms. The figure illustrates how each word describing the disease is represented by a corresponding vector (74a, 74b, 74c, 74d, 74e). The words in the figure are from an example of diabetes: Increased urination—74a; tiredness—74b, —74c, thirst—74d, and weight loss—74e. Each of the unique words (portion of the characteristics) has its own direction in the multi-dimensional coordinate system (in the figure only 3 directions are illustrated). The length of each of these portions of the characteristics (74a, 74b, 74c, 74d, 74e) depends on the uniqueness of each word. The words (portion of the characteristics) with the greatest uniqueness have the longest vector length. In FIG. 3, we see that Increased Urination (74a) is the longest vector as this is the most unique word. To keep track of the different uniqueness of each word (portion of the characteristics) an adaptive dictionary is created (74g) that keeps track of every word that is crawled (80) from all sources (90-140 of FIG. 1) for all diseases. This adaptive dictionary (74g) counts the number of occurrences of words (portion of the characteristic) for all diseases. The uniqueness is invers proportional to the number of instances. The words (portion of the characteristic) with fewest occurrences is the most unique. In the adaptive dictionary (74g) we see that Increased Urination is most unique with the value 10, while Tiredness is the least unique with a relative value of 2. In addition to the uniqueness of the word, the number of occurrences of the word related to a disease is counted. If there are many instances this increases the length of the vector. If words are centrally arranged in the text, such as in the headline or with a bigger font size this can be seen as significant and cause the vector to increase its length. It is also possible to combine and/or concatenate multiple words in one vector. This means in practice that one gets more directions, the principles however, are the same. To create a mathematical expression for the characteristics of a disease, all portion of the characteristics vectors are summed (74a, 74b, 74c, 74d, 74e) to form a resultant vector (74f) which is the sum of all the others. The resultant vector (74f) is a fingerprint or mathematical representation of disease characteristics. It is also possible to combine multiple characteristics to create new fingerprint for combinations of characteristics. It is possible to combine the different characteristics vectors (74) such symptom, location of the pain, duration or other relevant symptoms and characteristics to form a main vector for the overall disease.

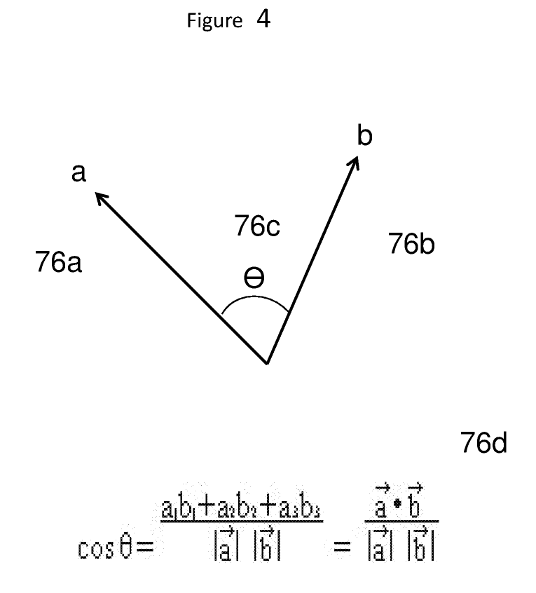

In FIG. 4 the Mathematical comparison of the characteristics of two diseases/symptoms is shown by how the two diseases, each represented by corresponding vector a (76a) and b (76b), are compared by taking the scalar product of the vectors as demonstrated by the mathematical equations in FIG. 4 (76d). The Scalar product is an expression for the direction (angle between the vectors) and length of the vectors. The characteristics of two diseases pointing in the same direction and with relatively equal length are two diseases with the same characteristics. In searches for diseases and matching between these the resemblance is defined by an expression converted to a %-scale (0-100%) corresponding to the results of the scalar product. This makes it much easier for the user to read how similar two diseases are. In FIG. 3, we saw how a disease characteristics is represented using a mathematical vector.

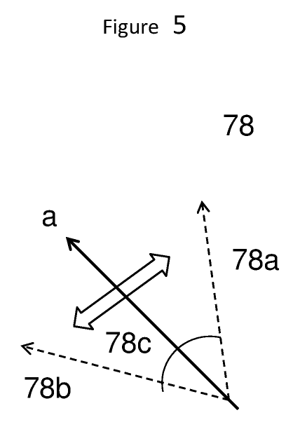

In FIG. 5 defining Mathematical changing of a disease symptom, we see how the change of a disease characteristic causes a change in the disease vector. Since the information sources (90-140) from FIG. 1 is read continuously and associated vectors calculated continuously, all changes will influence the direction and length of a disease characteristics. By continuously monitoring how rapid and large these changes are, this will reflect the nature of the change. This is done by continuously “derivation” of the disease characteristics or measure how big the changes in the vector are. This is illustrated in FIG. 5 where vector a (78c) varies to the direction and length indicated below by the dotted line (78b) or to the direction and length indicated by the dotted line above (78a). The size of this fluctuation (78c) is given by the derivative of the vector and is an expression of how great the change has been for a disease. This change may comprise that a patient gets a new symptom, change in pain intensity, or other relevant change. If these changes are intended for any of the user's relatives, family, friends, others who care, professional practitioners such as doctors, nurses, researchers, therapists, or others connected to the user's health and medicine that the user has connected in his/hers social networks (50) they will get an “early warning” on this. This way, a user may automatically get “tips” about changes very quickly and then be able to provide countermeasures if desired.

1. Method and arrangement for matching of diseases and detection of changes for a disease by the use of mathematical models that make it possible to match, find similar diseases, characteristics shared by two or more diseases based on a set of symptoms and to detect changes in a disease, comprising:
combining information of the disease collected by search engine technology and representing the disease characteristics using vector mathematics;
the search engines continuously monitoring and reacting web pages of information sources such as public hospitals, private clinics and alternative treatments, medical databases, private and public registers, on-line medical experts, News, Forums, Blogs, social networks and user feedback;
categorizing the information as characteristics of symptoms that may comprise: location on the body, pain intensity, shape, color, duration of persistence of the symptoms, and other relevant categories;
converting the information to mathematical vectors representing the disease characteristics;
comparing the diseases by taking the scalar product between diseases characteristics vectors; and
expressing the changes for a disease characteristics as changes of vector characteristics in regards of speed, length, and direction.

2. Method and arrangement according to claim 1, the disease characteristics is represented as the mathematical vector in a multi-dimensional coordinate system, wherein each direction represents a unique word representing a portion of the characteristics.

3. Method and arrangement according to claim 2, the disease characteristics vector comprises the sum of each portion of the characteristics consisting of vectors represented by one or more unique words or combinations and/or concatenations of words.

4. Method and arrangement according to claim 3, the portion of the characteristics vector has a length which is inversely proportional to the total word occurrence given by an adaptive dictionary and proportional to the occurrence, location, size or significance of a disease.

5. Method and arrangement according to claim 1, comparing one or several diseases by taking the scalar product which is then converted to a readable value between 0-100%.

6. Method and arrangement according to claim 1, representing the change in a disease as changes in the direction and length of the disease characteristics vector by observing the derivative of the vector.

7. Method and arrangement according to claim 1, representing the disease characteristics as a vector with a normalized length and stored it in a database, the length calculation being calculated dynamically at the time of the comparison, and thereby reflecting at all times the adaptive dictionary which is constantly updated by crawling of the information sources.

8. Method and arrangement according to claim 1, a disease vector may comprise one or more of disease vector characteristics.

9. Method and arrangement according to claim 1, overriding the length of a vector given by the adaptive dictionary for the disease due to other priorities that are important for the disease comprising but not limited to: new research, location, age, gender, patient profile, test results, new medicaments or other relevant reasons.

10. Method and arrangement according to claim 1, the matching of a disease may combine vector comparison with several other parameters comprising but not limited to: regulations, external influences, strategies or other requests that are of importance to the disease or its environment.

11. Method and arrangement according to claim 1, changes in a disease vectors leads to “early warning” being sent as a message to users of the method.

12. Method and arrangement according to claim 1, vectors of the diseases that have relatively similar direction and length can automatically initiates creation of groups of diseases that share many common features.

13. Method and arrangement according to claim 1, changes in the diseases vectors lead to detection of new research results, treatment methods and other changes appearing during an illness.

14. Method and arrangement according to claim 1, changes in the diseases vectors lead to detection of positive or negative direction for a disease development.

15. Method and arrangement according to claim 1, changes in the diseases vectors lead to detection of new treatment procedures, or other medical effects.

16. Method and arrangement according to claim 1, changes in the diseases vectors lead to detection of new diseases and symptoms based on trends of other diseases development and change.

17. Method and arrangement according to claim 1, the disease vectors based on information from forums, blogs, social networking, News, or users, can provide a live indication of disease development, symptoms, treatments and medication status and its development in positive or negative direction by comparing with defined positive and negative vectors.
